(19) United States
(12) Patent Application Publication
(10) Pub. No.: US 2014/0196422 A1
(43) Pub. Date: Jul. 17, 2014

(54) WAVY COMPOSITE CORE AND MANUFACTURING METHOD THEREOF

(71) Applicant: PRO-PURE INC., NEW TAIPEI CITY (TW)

(72) Inventors: Hsiang-Chi LIN, NEW TAIPEI CITY (TW); Rong-Wei CHEN, NEW TAIPEI CITY (TW)

(73) Assignee: PRO-PURE INC., NEW TAIPEI CITY (TW)

(21) Appl. No.: 14/063,497

(22) Filed: Oct. 25, 2013

(30) Foreign Application Priority Data
Jan. 15, 2013 (TW) 102101420

(51) Int. Cl. B01D 46/52; B01D 67/00

(52) U.S. Cl. CPC B01D 46/527; B01D 67/00
USPC 55/498; 156/210

(57) ABSTRACT

A wavy composite core is provided. The wavy composite core includes wavy filtering layers and flat filtering layers alternately stacked and rolled to form a barrel shape for filtering suspended pollutants. Each wavy filtering layer has a plurality of peak portions extending axially, a plurality of axial sealing adhesive layers formed on the peak portions by coating sealing adhesive on the peak portions so as to bond the wavy filtering layer to the flat filtering layers adjacent to the wavy filtering layer, and two end sealing adhesive layers formed on opposite sides by coating sealing adhesive on the wavy filtering layer to bond the wavy filtering layer to the adjacent flat filtering layers.

### CROSS-REFERENCE TO RELATED APPLICATIONS

This application is based upon and claims priority under 35 U.S.C. 119 from Taiwan Patent Application No. 102101420 filed on Jan. 15, 2013, which is hereby specifically incorporated herein by this reference thereto.

### BACKGROUND OF THE INVENTION

1. Field of the Invention

The invention relates to a wavy composite core and a manufacture method thereof, and in particular to a wavy composite core for filtering suspended particles from fluid.

2. Description of the Prior Arts

A conventional core for a filtering device is shaped as a barrel. A filtering layer for filtering suspended pollutants forms a periphery wall of the core, and holding members are disposed at two ends of the barrel to hold the filtering layer and seal both ends of the filtering layer. Fluid with pollutants flows into the filtering device via the periphery wall of the barrel where the suspended particles are filtered by the filtering layer. The filtered fluid flows axially along the hollow portion of the core to exit the filtering device. However, the filtering path length for the suspended particles is equal to the wall thickness of the core such that the filtering path is too short to have a preferred filtering effect.

The conventional core is improved to have a periphery wall including wavy filtering layers and flat filtering layers which are alternately stacked. The fluid with pollutants flows from one end of the conventional core, and the filtered fluid flows out of the core from the other end. Since adjacent layers of the core are sealed at different ends, the fluid entering one layer of the core at one end must flow through the wavy filtering layer to the adjacent flat layer to flow out of the core at the other end. In such a structure, the filtering path length is equal to the axial length of the core rather than the wall thickness of the core. The filtering area is increased for the same volume of the core, whereby the filtering efficiency and ability of the core is increased.

However, since the wavy filtering layers and the flat filtering layers are bonded only at both ends, gaps may exist between the wavy and flat filtering layers, and the fluid with pollutants may flow in the gaps directly without passing through the wavy filtering layers. In addition, when the wavy filtering layers and the flat filtering layers are not well bonded, the wavy filtering layers may shift relative to the flat filtering layers in a high negative pressure condition, which damages the sealed structure such that the filtering layers are unable to filter the suspended particles.

To overcome the shortcomings, the present invention provides a wavy composite core to mitigate or obviate the aforementioned problems.

### SUMMARY OF THE INVENTION

An object of the invention is to provide a wavy core having a structure which forces air to flow through wavy and flat filtering layers so as to separate suspended particles and increase the bonding strength between the wavy filtering layer and the flat filtering layer.

To achieve the object above, the invention provides a wavy composite core that includes multiple wavy filtering layers and multiple flat filtering layers alternately stacked and rolled to form a barrel for filtering suspended pollutants, wherein each wavy filtering layer has a plurality of peak portions extending axially, a plurality of axial sealing adhesive layers formed on the peak portions by coating sealing adhesive on the peak portions so as to bond the wavy filtering layer to the flat filtering layers adjacent to the wavy filtering layer, and two end sealing adhesive layers formed on opposite sides by coating sealing adhesive on the wavy filtering layer to bond the wavy filtering layer to the adjacent flat filtering layers.

The invention also provides a manufacturing method for the wavy composite core, which includes the following steps: (a) forming a wavy filtering layer and a flat filtering layer for filtering suspended pollutants, wherein raw material is pressed by shaping rollers to form the wavy filtering layer having peak portions on which axial sealing adhesive layers are formed by coating sealing adhesive on the peak portions, and the raw material is tensioned by a driving roller and a press roller to form the flat filtering layer simultaneously; (b) forming a first end sealing adhesive layer and bonding the wavy filtering layer to the flat filtering layer, wherein the first end sealing adhesive layer is formed on the wavy filtering layer by coating sealing adhesive at one end on one side of the wavy filtering layer by a first gluing gun, and the flat filtering layer is pressed and bonded to the wavy filtering layer by means of the axial sealing adhesive layers and the first end sealing adhesive layer; (c) forming a second end sealing adhesive layer, wherein the second end sealing adhesive layer is formed on the wavy filtering layer by coating sealing adhesive at the other end on the other side of the wavy filtering layer by a second gluing gun; (d) obtaining the wavy composite core, wherein the bonded wavy filtering layer and flat filtering layer are rolled to form the wavy composite core having a barrel shape.

The advantages of the invention are described as follows. Only one end of each side of the wavy filtering layer is sealed, and the axial sealing adhesive layers are formed on the peak portions to seal the gap between the wavy filtering layer and the flat filtering layer. When the fluid with pollutants enters the wavy filtering layer from one end on one side of the wavy filtering layer, the fluid is unable to flow out from the other end of the same side of the wavy filtering layer, and there is no gap allowing the fluid to flow to the other side, the fluid with pollutants must pass through the wavy filtering layer to flow out of the wavy filtering layer at the other end on the other side, which ensures that the pollutants are filtered from the air. The axial sealing adhesive layers increase the bonding strength between the wavy filtering layer and the flat filtering layer and prevent the damage of the sealed structure.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portion of a wavy composite core in accordance with the present invention;

FIG. 2 is an enlarged perspective view of a portion of the wavy composite core in FIG. 1;

FIG. 3 is an exploded perspective view of the wavy composite core in FIG. 1 along with a shaft;

FIG. 4 is a perspective view of the wavy composite core in FIG. 1 assembled to a shaft;

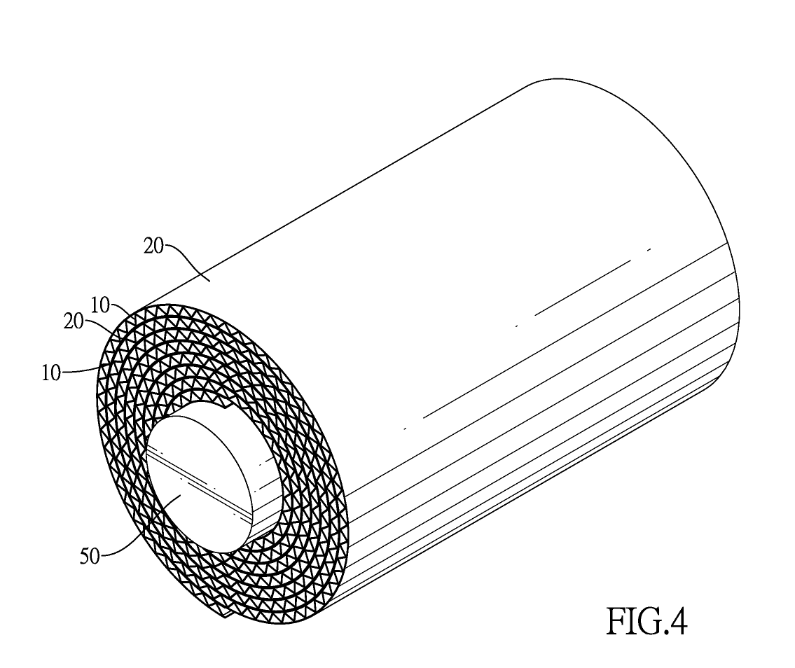

FIG. 5 is a schematic view of equipment utilized for a manufacturing method for manufacturing a wavy composite core in accordance with the present invention; and

FIG. 6 is a flow chart of the manufacturing method for manufacturing the wavy composite core material in accordance with the present invention.

### DETAILED DESCRIPTION OF THE PREFERRED EMBODIMENTS

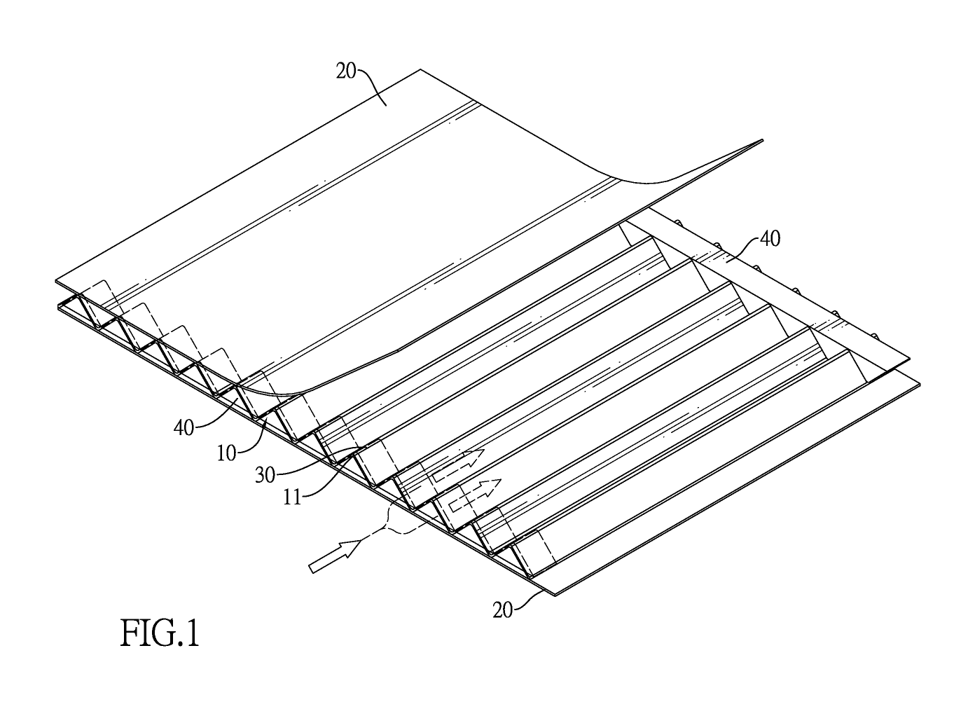

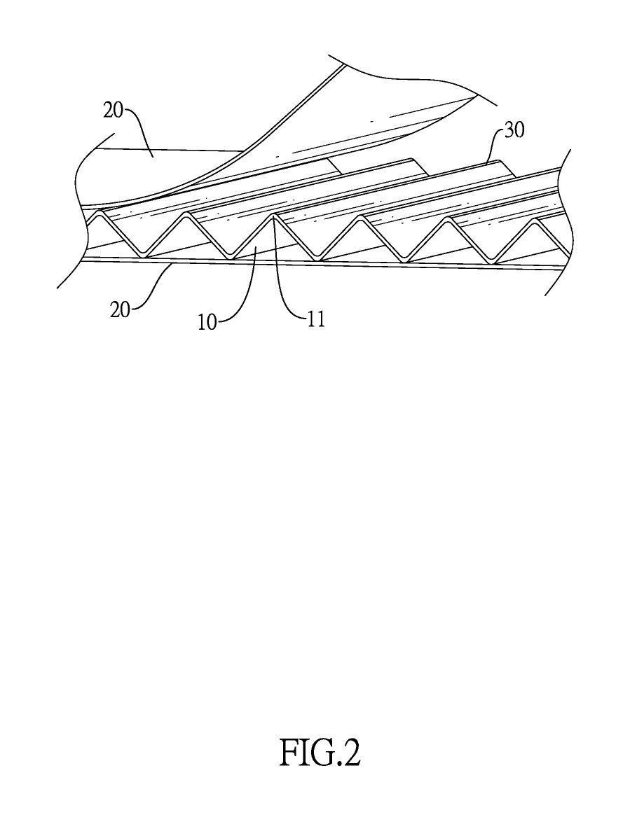

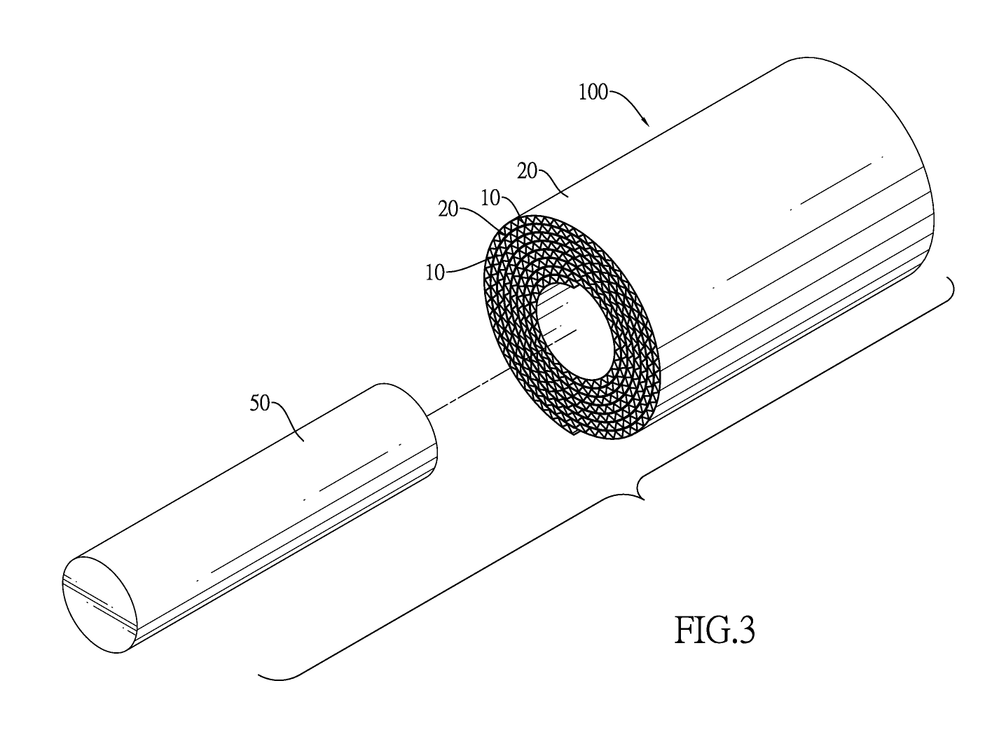

Referring to FIGS. 1 to 3, a wavy composite core 100 in accordance with the present invention comprises multiple wavy filtering layers 10 and multiple flat filtering layers 20 for filtering suspended particles. The wavy filtering layers 10 are bonded to the flat filtering layers 20. The wavy filtering layers 10 and the flat filtering layers 20 are rolled to form a barrel, and a shaft 50 is inserted into the barrel. The wavy filtering layers 10 and the flat filtering layers 20 are alternately stacked to form a periphery wall of the barrel. Each wavy filtering layer 10 has peak portions 11 on which an axial sealing adhesive layer 30 is coated. Each wavy filtering layer 10 is bonded to the flat filtering layers 20 adjacent to the wavy filtering layer 10 by the axial sealing adhesive layer 30. Two end sealing adhesive layers 40 are respectively coated on two sides of the wavy filtering layer 10 and are coated at opposite ends of the wavy filtering layer 10 to bond the wavy filtering layer 10 to the flat filtering layers 20. Each wavy filtering layer 10 has a first side and a second side. In a preferred embodiment, the wavy filtering layer 10 further has a first end and a second end opposite the first end. One of the end sealing adhesive layers 40 is coated at the first end on the first side of the wavy filtering layer 10 and the other one of the end sealing adhesive layers 40 is coated at the second end on the second side of the wavy filtering layer 10. It is also feasible that the end sealing adhesive layers 40 are respectively coated at the second end on the first side and at the first end on the second side of the wavy filtering layer 10.

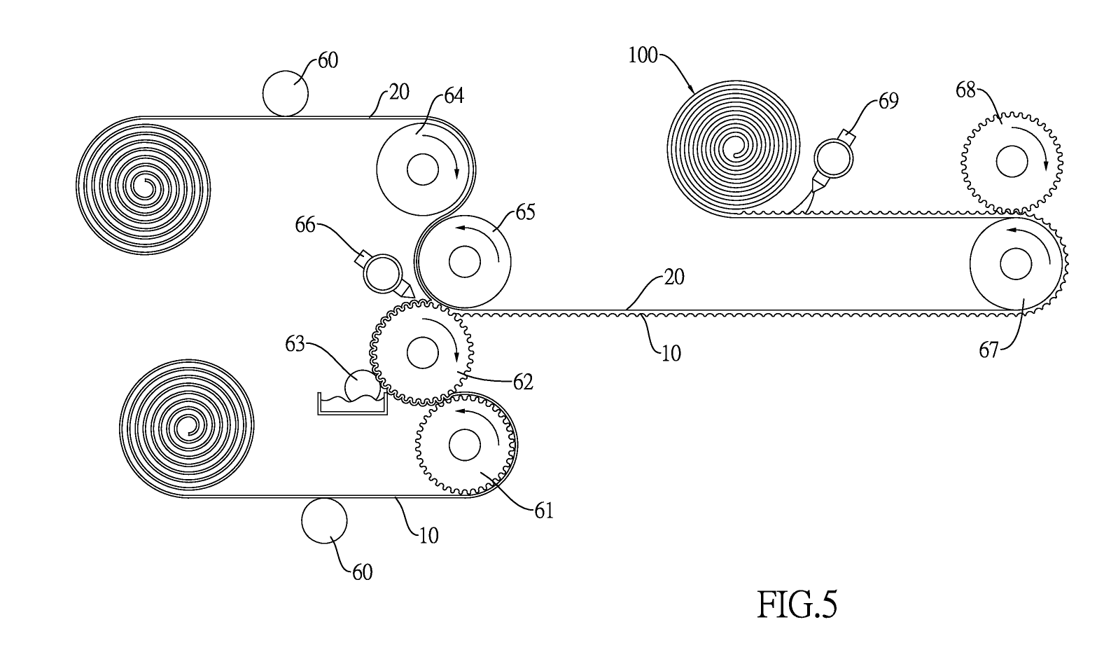

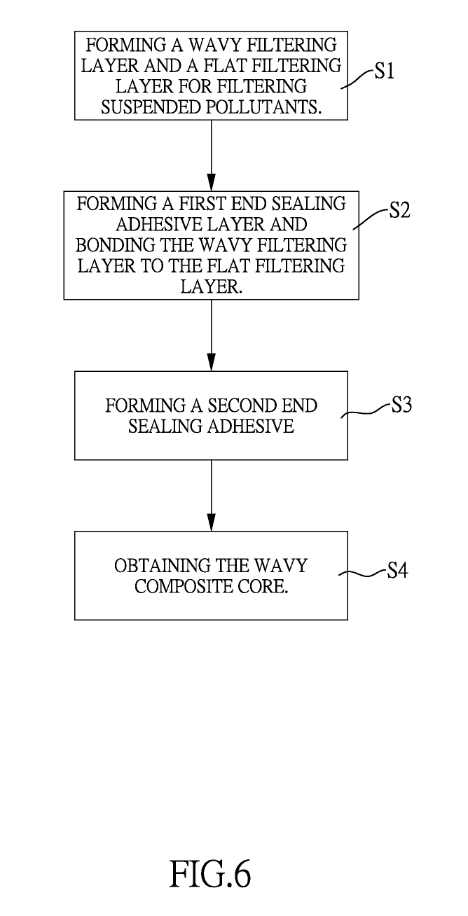

Referring to FIGS. 5 and 6 and in view of FIG. 1, an equipment utilized for a manufacturing method for manufacturing the wavy composite core in accordance with the present invention comprises two tension rollers 60, a lower shaping roller 61, an upper shaping roller 62, an upper gluing roller 63, a front driving roller 64, a press roller 65, a first gluing gun 66, an annular driving roller 67, a toothed roller 68 and a second gluing gun 69. The lower shaping roller 61 and the upper shaping roller 62 have wavy surfaces and engage with each other. The gluing roller 63 is adjacent to the upper shaping roller 62, the front driving roller 64 is adjacent to the press roller 65, and the press roller 65 is adjacent to the upper shaping roller 62. The first gluing gun 66 is disposed near adjacency to the pressing roller 65 and the upper shaping roller 62. The annular driving roller 67 is adjacent to the toothed roller 68 having a wavy surface. The second gluing gun 69 is disposed near the toothed roller 68. The manufacturing method comprises the following steps.

The first step (S1) is to form a wavy filtering layer 10 and a flat filtering layer 20 for filtering suspended pollutants. Raw material for the wavy filtering layer 10 and the flat filtering layer 20 is conveyed by the tension rollers 60 respectively. The raw material for the wavy filtering layer 10 is preheated by the lower shaping roller 61 in advance and shaped by the upper shaping roller 62 to form the wavy shape. The preheating rapidly shapes the wavy filtering layer 10 and maintains the wavy profile of the wavy filtering layer 10. When the wavy shape is formed, the axial sealing adhesive layer 30 is coated on each peak portion 11 by the gluing roller 63, and the raw material is tensioned by the front driving roller 64 and the press roller 65 to form the flat filtering material 20.

The second step (S2) is to form a first end sealing adhesive layer 40 and bond the wavy filtering layer 10 to the flat filtering layer 20. After the wavy filtering layer 10 is conveyed by the upper shaping roller 62, the first gluing gun 66 distributes sealing adhesive to the first end on the first side to form the first end sealing adhesive layer 40. After the flat filtering layer 20 is conveyed by the press roller 65, the flat filtering layer 20 is bonded to the wavy filtering layer 10 by the first end sealing adhesive layer 40 and the axial sealing adhesive layer 30. The bonded wavy filtering layer 10 and flat filtering layer 20 are still conveyed by the press roller 65. The press roller 65 cools the first end sealing adhesive layer 40 and the axial sealing adhesive layer 30 rapidly to maintain the shape and evenly distribute the adhesive.

The third step (S3) is to form a second end sealing adhesive layer 40. The bonded wavy filtering layer 10 and flat filtering layer 20 are conveyed by the annular driving roller 37 to engage with the toothed roller 68. The bonded wavy filtering layer 10 and flat filtering layer 20 are further conveyed by the toothed roller 68, and the second gluing gun 69 distributes sealing adhesive at the second end on the second side of the wavy filtering layer 10 to form the second end sealing adhesive layer 40.

The fourth step (S4) is to obtain a product of the wavy composite core 100. The bonded wavy filtering layer 10 and flat filtering layer 20 are rolled up, and the wavy filtering layer 10 is further bonded to the flat filtering layer 20 adjacent to the wavy filtering layer 10 by the second end sealing adhesive layer 40 to obtain the barrel-shaped product.

With reference to FIG. 1, the fluid with pollutants flows into the wavy composite core 100 from one end on one side of the wavy composite core 100. Since the end sealing adhesive layers 40 are formed on opposite ends, the fluid with pollutants is obstructed by the end sealing adhesive layers 40 at the other end and thus is forced to pass through the wavy filtering layer 10 to the other side to flow out at the other end on the other side of the wavy composite core 100. The axial sealing adhesive layer 30 increases the bonding strength between the wavy filtering layer 10 and the flat filtering layer 20 to maintain the bonding structure for filtering the suspended pollutants.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wavy composite core comprising a plurality of wavy filtering layers and a plurality of flat filtering layers alternately stacked and rolled to form a barrel for filtering suspended pollutants, wherein each wavy filtering layer has a plurality of peak portions extending axially, a plurality of axial sealing adhesive layers formed on the peak portions by coating sealing adhesive on the peak portions so as to bond the wavy filtering layer to the flat filtering layers adjacent to the wavy filtering layer, and two end sealing adhesive layers formed on opposite ends of the wavy filtering layer by coating sealing adhesive on the wavy filtering layer to bond the wavy filtering layer to the adjacent flat filtering layers.

2. The wavy composite core as claimed in claim 1, wherein each wavy filtering layer has a first side, a second side, a first end and a second end opposite the first end, one of the end sealing adhesive layers is formed on the first side at the first end, and the other end sealing adhesive layer is formed on the second side and at the second end.

3. The wavy composite core as claimed in claim 1, wherein each wavy filtering layer has a first side, a second side, a first end and a second end opposite the first end, one of the end sealing adhesive layers is formed on the second side at the first end, and the other end sealing adhesive layer is formed on the first side and at the second end.

4. A manufacturing method for a wavy composite core, comprising the following steps:
(a) forming a wavy filtering layer and a flat filtering layer for filtering suspended pollutants, wherein raw material is pressed by shaping rollers to form the wavy filtering layer having peak portions on which axial sealing adhesive layers are formed by coating sealing adhesive on the peak portions, and the raw material is tensioned by a driving roller and a press roller to form the flat filtering layer at the same time;
(b) forming a first end sealing adhesive layer and bonding the wavy filtering layer to the flat filtering layer, wherein the first end sealing adhesive layer is formed on the wavy filtering layer by coating sealing adhesive at one end on one side of the wavy filtering layer by a first gluing gun, and the flat filtering layer is pressed and bonded to the wavy filtering layer by means of the axial sealing adhesive layers and the first end sealing adhesive layer;
(c) forming a second end sealing adhesive layer, wherein the second end sealing adhesive layer is formed on the wavy filtering layer by coating sealing adhesive at the other end on the other side of the wavy filtering layer by a second gluing gun; and
(d) obtaining the wavy composite core material, wherein the bonded wavy filtering layer and flat filtering layer are rolled to form the wavy composite core having a barrel shape.

5. The manufacturing method as claimed in claim 4, wherein in the step (a), raw material is conveyed through a lower shaping roller to be preheated and through an upper shaping roller to form a wavy shape.

6. The manufacturing method as claimed in claim 5, wherein in the step (b), the press roller conveys and cools the bonded wavy filtering layer and flat filtering layer.

7. The manufacturing method as claimed in claim 6, wherein in the step (c), the bonded wavy filtering layer and flat filtering layer are conveyed by an annular driving roller to engage with a toothed roller and moved by the toothed roller to the second gluing gun.

8. The manufacturing method as claimed in claim 7, wherein in the step (a), the sealing adhesive is coated on the peak portions by a gluing roller.

9. The manufacturing method as claimed in claim 5, wherein in the step (c), the bonded wavy filtering layer and flat filtering layer are conveyed by an annular driving roller to engage with a toothed roller and moved by the toothed roller to the second gluing gun.

10. The manufacturing method as claimed in claim 5, wherein in the step (a), the sealing adhesive is coated on the peak portions by a gluing roller.

11. The manufacturing method as claimed in claim 4, wherein in the step (b), the press roller conveys and cools the bonded wavy filtering layer and flat filtering layer.

12. The manufacturing method as claimed in claim 11, wherein in the step (c), the bonded wavy filtering layer and flat filtering layer are conveyed by an annular driving roller to engage with a toothed roller and moved by the toothed roller to the second gluing gun.

13. The manufacturing method as claimed in claim 12, wherein in the step (a), the sealing adhesive is coated on the peak portions by a gluing roller.

14. The manufacturing method as claimed in claim 4, wherein in the step (c), the bonded wavy filtering layer and flat filtering layer is conveyed by an annular driving roller to engage with a toothed roller and moved by the toothed roller to the second gluing gun.

15. The manufacturing method as claimed in claim 4, wherein in the step (a), the sealing adhesive are coated on the peak portions by a gluing roller.
